(19) United States
(12) Patent Application Publication
(10) Pub. No.: US 2009/0222732 A1
(43) Pub. Date: Sep. 3, 2009

(54) SYSTEM AND METHOD FOR SERVER-DIRECTED DOCUMENT INPUT VIA A DOCUMENT PROCESSOR INTERFACE

(76) Inventors: Ajit SODHI, Irvine, CA (US); Andrey Savov, Fullerton, CA (US); William Su, Riverside, CA (US); Hongfeng Wei, Cerritos, CA (US); Marianne Kodimer, Huntington Beach, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/394,498

(22) Filed: Feb. 27, 2009

Related U.S. Application Data
(60) Provisional application No. 61/032,498, filed on Feb. 29, 2008.

(51) Int. Cl. G06F 3/00; G06F 15/173

(52) U.S. Cl. 715/733; 709/238

(57) ABSTRACT

The subject application is directed to a system and method for server-directed document input via a document processor interface. A thin client interface is generated on a graphical display associated with a document processing device via a web server. The document processing device is controlled via a controller using software instructions. User instructions relative to a scanning operation are then received and data corresponding to the user instructions is communicated to the server via a network interface. The server receives the user instructions and generates device control instructions. The control instructions are communicated to the controller of the processing device. Operation of a scanner integrated with the processing device is commenced and scanning is performed of an electronic document from a tangible document positioned on the scanner according to the device control instructions. The electronic document is communicated from the processing device to the server via the network interface.

### CROSS-REFERENCE TO RELATED APPLICATIONS

This Application claims priority to U.S. Provisional Patent Application Ser. No. 61/032,498, titled A SYSTEM AND METHOD FOR THIN-CLIENT WEB-BASED DOCUMENT PROCESSING, filed on Feb. 29, 2008, the entirety of which is incorporated herein.

### BACKGROUND OF THE INVENTION

The subject application is directed generally to web-based processing of electronic documents. More particularly, the subject application is directed to accessing document processing services at a document processing device via a thin-client interface. In particular, the subject application is directed to a system and method for providing thin-client web-based document processing services.

Document processing devices are in widespread use today and include copiers, printers, scanners, facsimile machines, plotters, electronic mail gateways, and the like. More recently, two or more of such machine functions have been combined into a single device, referred to as a multifunction peripheral or MFP.

Such document processing devices typically include a variety of capabilities, each of which may require dedicated software, hardware, or a combination thereof. In such circumstances, each of the devices would then require a single copy of any such software be incorporated prior to roll-out of the device. Many enterprises will distribute document processing devices throughout an office, within a building, among multiple buildings, or among multiple locations. In such circumstances, each device is expected to incorporate a variety of processing capabilities, such as optical character recognition, image correction, and the like. The expense of incorporating copies of each software application in such document processing devices increases, particularly when multiple devices are deployed

### SUMMARY OF THE INVENTION

In accordance with one embodiment of the subject application, there is provided a system and method for server-directed document input via a document processor interface. A thin client interface is first generated operable on a graphical display associated with a document processing device via a web server. Preferably, the document processing device has a processor and memory in network data communication with the web server. The document processing device is controlled via a local controller equipped with a processor and memory using software instructions. User input is then received via the graphical display representative of user instructions relative to commencement of a document scanning operation. Data corresponding to the received user instructions is then communicated to the web server via a network interface. The web server receives the data corresponding to the received user instructions and generates device control instructions corresponding to the received user instructions. The device control instructions are then communicated to the document processing device via the network interface. The local controller associated with the document processing device receives the device control instructions. Operation of a scanner integrated with the document processing device is then commenced in accordance with the received device control instructions. Scanning is then performed by the scanner of an electronic document corresponding to a tangible document positioned relative to the scanner in accordance with received device control instructions. Thereafter, the electronic document is communicated from the document processing device to the web server via the network interface.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for server-directed document input via a document processor interface according to one embodiment of the subject application;

FIG. 2 is a block diagram illustrating device hardware for use in the system for server-directed document input via a document processor interface according to one embodiment of the subject application;

FIG. 3 is a functional diagram illustrating the device for use in the system for server-directed document input via a document processor interface according to one embodiment of the subject application;

FIG. 4 is a block diagram illustrating controller hardware for use in the system for server-directed document input via a document processor interface according to one embodiment of the subject application;

FIG. 5 is a functional diagram illustrating the controller for use in the system for server-directed document input via a document processor interface according to one embodiment of the subject application;

FIG. 6 is a functional diagram illustrating a server for use in the system for server-directed document input via a document processor interface according to one embodiment of the subject application;

FIG. 7 is a block diagram illustrating the system for server-directed document input via a document processor interface according to one embodiment of the subject application;

FIG. 8 is a functional diagram illustrating the system for server-directed document input via a document processor interface according to one embodiment of the subject application;

FIG. 9 is a flowchart illustrating a method for server-directed document input via a document processor interface according to one embodiment of the subject application; and

FIG. 10 is a flowchart illustrating a method for server-directed document input via a document processor interface according to one embodiment of the subject application.

### DETAILED DESCRIPTION OF THE PREFERRED EMBODIMENT

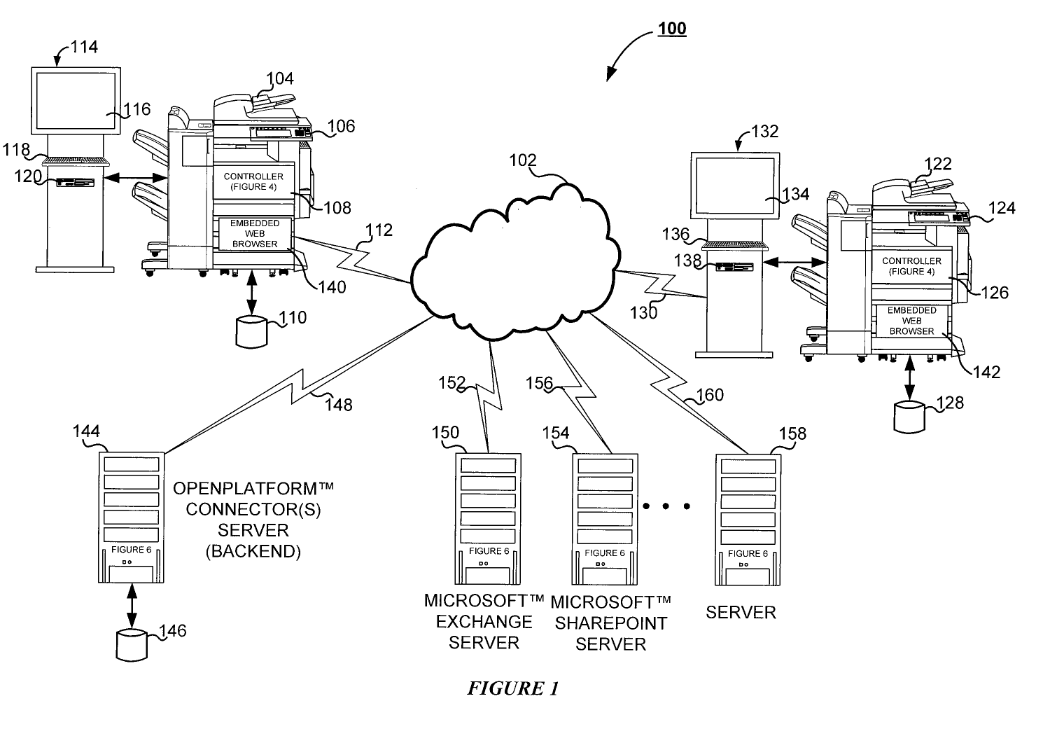

The subject application is directed to a system and method for web-based operations of an associated document processing device. In particular, the subject application is directed to a system and method for providing web-based document processing services to an associated user via a thin-client interface in data communication with a backend server. More particularly, the subject application is directed to a system and method for providing thin-client web-based document processing services. It will become apparent to those skilled in the art that the system and method described herein are suitably adapted to a plurality of varying electronic fields employing web-based services, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for providing server-directed document input via a document processor interface in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

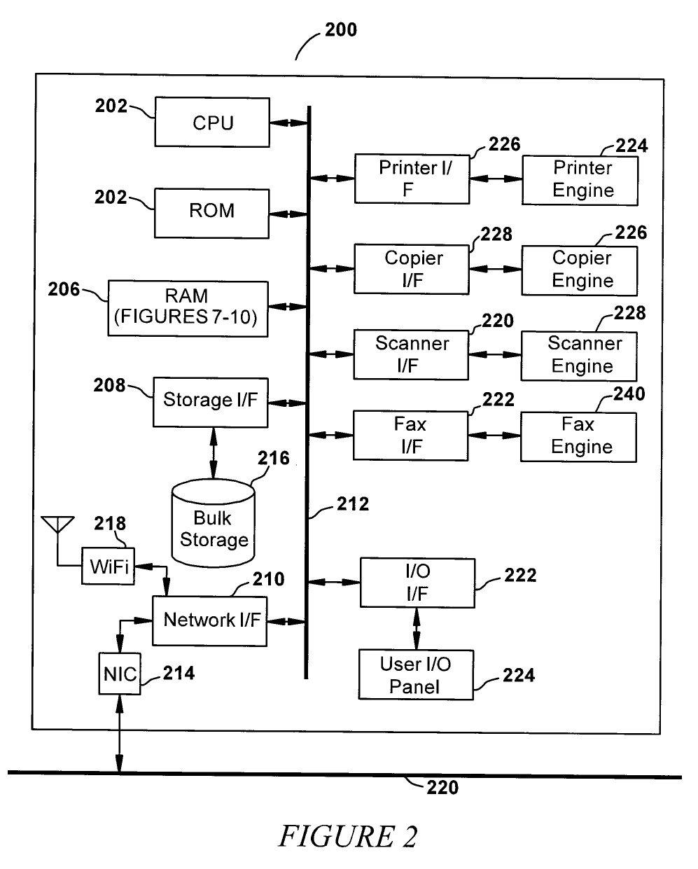

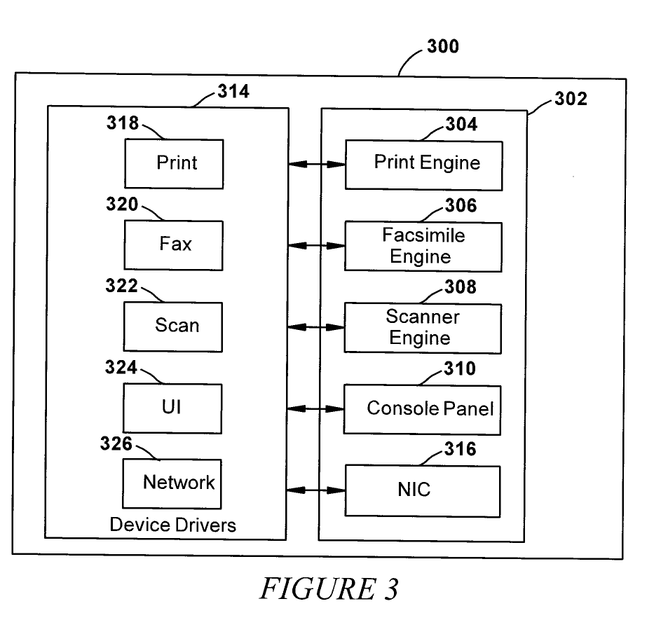

The system 100 also includes a first document processing device 104 and a second document processing device 122, which are depicted in FIG. 1 as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing devices 104 and 122 are suitably adapted to provide remote document processing services to external or network devices. Preferably, the document processing devices 104 and 122 include hardware, software, and any suitable combination thereof, configured to interact with an associated user, a networked device, or the like. The functioning of the document processing devices 104 and 122 will better be understood in conjunction with the block diagrams illustrated in FIGS. 2 and 3, explained in greater detail below.

According to one embodiment of the subject application, the document processing devices 104 and 122 are suitably equipped to receive a plurality of portable storage media, including, without limitation, Firewire drive, USB drive, SD, MMC, XD, Compact Flash, Memory Stick, and the like. In the preferred embodiment of the subject application, the document processing devices 104 and 122 further include associated user interfaces 106 and 124, such as touch-screens, LCD displays, touch-panels, alpha-numeric keypads, or the like, via which an associated user is able to interact directly with the respective document processing device 104 or 122. In accordance with the preferred embodiment of the subject application, the user interfaces 106 and 124 are advantageously used to communicate information to the associated user and receive selections from the associated user. The skilled artisan will appreciate that the user interfaces 106 and 124 comprise various components, suitably adapted to present data to the associated user, as are known in the art. In accordance with one embodiment of the subject application, each of the user interfaces 106 and 124 comprises a display, suitably adapted to display one or more graphical elements, text data, images, or the like, to an associated user, receive input from the associated user, and communicate the same to a backend component, such as the controllers 108 and 126, as explained in greater detail below. Preferably, the document processing devices 104 and 122 are communicatively coupled to the computer network 102 via corresponding communications links 112 and 130. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

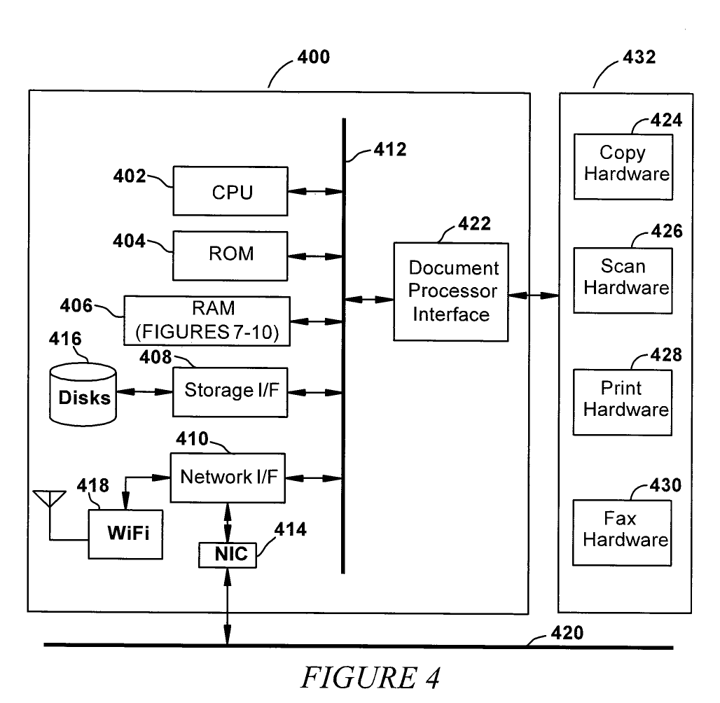

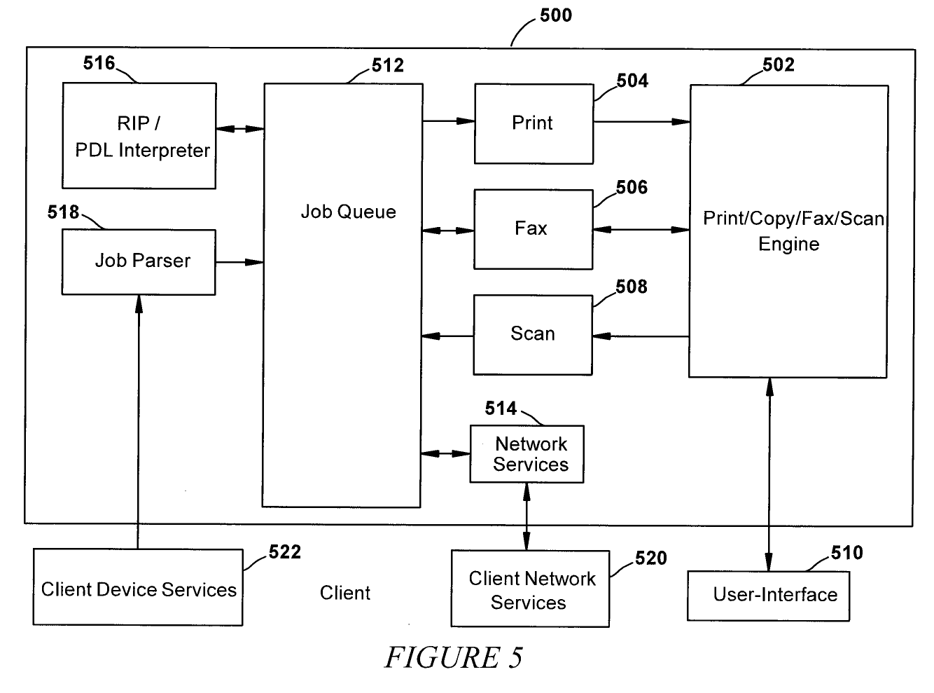

In accordance with one embodiment of the subject application, each of the document processing devices 104 and 122 further incorporates a backend component, designated as the controllers 108 and 126, suitably adapted to facilitate the operations of the corresponding document processing device 104 and 122, as will be understood by those skilled in the art. Preferably, the controllers 108 and 126 are embodied as hardware, software, or any suitable combination thereof, configured to control the operations of the associated document processing device 104 or 122, facilitate the display of images via the user interface 106 or 124, direct the manipulation of electronic image data, and the like. For purposes of explanation, the controllers 108 and 126 are used to refer to any myriad of components associated with the document processing devices 104 and 122, including hardware, software, or combinations thereof, functioning to perform, cause to be performed, control, or otherwise direct the methodologies described hereinafter. It will be understood by those skilled in the art that the methodologies described with respect to the controllers 108 and 126 are capable of being performed by any general purpose computing system, known in the art, and thus the controllers 108 and 126 are representative of such general computing devices and are intended as such when used hereinafter. Furthermore, the use of the controllers 108 and 126 hereinafter is for the example embodiment only, and other embodiments, which will be apparent to one skilled in the art, are capable of employing the system and method for server-directed document input via a document processor interface of the subject application. The functioning of the controllers 108 and 126 will better be understood in conjunction with the block diagrams illustrated in FIGS. 4 and 5, explained in greater detail below.

Communicatively coupled to the document processing devices 104 and 122 are corresponding data storage devices 110 and 128. In accordance with the preferred embodiment of the subject application, the data storage devices 110 and 128 are any mass storage devices known in the art including, for example and without limitation, magnetic storage drives, a hard disk drive, optical storage devices, flash memory devices, or any suitable combination thereof. In the preferred embodiment, the data storage devices 110 and 128 are suitably adapted to store document data, image data, electronic database data, or the like. It will be appreciated by those skilled in the art that while illustrated in FIG. 1 as being separate components of the system 100, the data storage devices 110 and 128 are capable of being implemented as an internal storage component of the associated document processing device 104 or 122, a component of the controllers 108 or 126, or the like, such as, for example and without limitation, an internal hard disk drive, or the like. In accordance with one embodiment of the subject application, the data storage devices 110 and 128 are capable of storing images, advertisements, user information, location information, output templates, mapping data, multimedia data files, fonts, and the like.

Illustrated in FIG. 1 are a first kiosk 114, communicatively coupled to the first document processing device 104, and in effect, the computer network 102, and a second kiosk 132, communicatively coupled to the second document processing device 122, and in effect, the computer network 102. It will be appreciated by those skilled in the art that the kiosks 114 and 132 are capable of being implemented as separate component of the respective document processing devices 104 and 122, or as integral components thereof. Use of the kiosks 114 and 132 in FIG. 1 are for example purposes only, and the skilled artisan will appreciate that the subject application is capable of implementation without the use of kiosks 114 and 132. In accordance with one embodiment of the subject application, the kiosks 114 and 132 include respective displays 116 and 134 and user input devices 118 and 136. As will be understood by those skilled in the art the kiosks 114 and 132 are capable of implementing a combination user input device/display, such as a touch screen interface. According to one embodiment of the subject application, the kiosks 114 and 132 are suitably adapted to display prompts to an associated user, receive instructions from the associated user, receive payment data, receive selection data from the associated user, and the like. Preferably, the kiosks 114 and 132 include a magnetic card reader, conventional bar code reader, or the like, suitably adapted to receive and read payment data from a credit card, coupon, debit card, or the like.

The system 100 of FIG. 1 also includes portable storage device readers 120 and 138, coupled to the kiosks 114 and 132 and suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

The document processing devices 104 and 122 depicted in FIG. 1 further include thin-client interfaces, e.g. embedded web-browsers 140 and 142. It will be appreciated by those skilled in the art that the embedded web-browsers 140 and 142 are capable of being implemented as components of the user interfaces 106 and 124, the kiosks 114 and 132, or the like. Preferably, the embedded web-browsers 140 and 142 are suitably adapted to communicate user input with a backend component, such as the server 144, display data to the user, and the like. As the skilled artisan will appreciate, suitable web-browsers include, for example and without limitation, MICROSOFT INTERNET EXPLORER, MOZILLA FIREFOX, APPLE SAFARI, or any other web-browser known in the art.

The system 100 of FIG. 1 also includes a backend component, illustrated as the server 144 and associated data storage device 146, communicatively coupled to the computer network 102 via a communications link 148. It will be appreciated by those skilled in the art that the server 144 comprises hardware, software, and combinations thereof suitably adapted to provide one or more services, web-base applications, document processing device command and control, storage options, and the like, to networked devices. In accordance with one embodiment of the subject application, the server 144 includes various components, implemented as hardware, software, or a combination thereof, for managing the retention of electronic data, performing searches, storing advertisements, storing account information, storing billing information, retrieval of documents, facilitating communications between a thin-client and a third-party server, controlling a document processing device, and the like, which are accessed via the computer network 102. The communications link 148 is any suitable data communications means known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. It will be appreciated by those skilled in the art that the components described with respect to the server 144 hereinafter are capable of implementation on any computing device coupled to the computer network 102 and functioning as a backend server. The skilled artisan will appreciate that suitable backend server configurations include, for example and without limitation, an OPENPLATFORM connectors server, or other such server, as are known in the art.

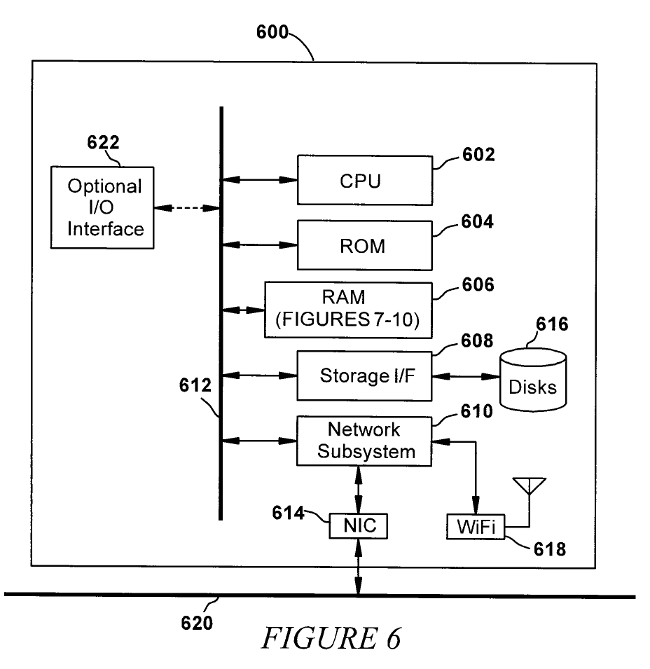

Communicatively coupled to the server 144 is the data storage device 146. In accordance with the preferred embodiment of the subject application, the data storage device 146 is any mass storage device, or plurality of such devices, known in the art including, for example and without limitation, magnetic storage drives, a hard disk drive, optical storage devices, flash memory devices, or any suitable combination thereof. In the preferred embodiment, the data storage device 146 is suitably adapted to store software updates, update lists, electronic database data, document data, image data, location data, advertisement data, account data, user data, and the like. It will be appreciated by those skilled in the art that while illustrated in FIG. 1 as being a separate component of the system 100, the data storage device 146 is capable of being implemented as internal storage component of the server 144, or the like, such as, for example and without limitation, an internal hard disk drive, or the like. The functioning of the server 144 will be better understood in conjunction with the illustration of FIG. 6, described in greater detail below.

The system 100 of FIG. 1 further includes a plurality of third-party or affiliated services providing servers, e.g. MICROSOFT EXCHANGE server 150, MICROSOFT SHAREPOINT server 154, application server 158, and the like. The servers 150, 154, and 158 comprise hardware, software, and combinations thereof suitably adapted to provide one or more services, web-base applications, document processing device command and control, storage options, and the like, to networked devices, such as the document processing devices 104 and 122. The servers 150, 154, and 158 are communicatively coupled to the computer network 102 via corresponding communications links 152, 156, and 160. It will be appreciated by those skilled in the art that suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The application server 158 is illustrated in FIG. 1 as a device representing one or more servers coupled to the network 102 so as to provide applications to a user associated with one of the document processing devices 104 or 122, e.g. optical character recognition, document management, or the like.

Turning now to FIG. 2, illustrated is a representative architecture of a suitable device 200 (shown in FIG. 1 as the document processing devices 104 and 122) on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, 5 scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controllers 108 and 126, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by the bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing devices 104 and 122, which includes the controller 400 of FIG. 4, (shown in FIG. 1 as the controllers 108 and 126, respectively) as an intelligent subsystem associated with a document processing device. In the illustration of FIG. 5, controller function 500 in the preferred embodiment includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a representative architecture of a suitable server 600 (shown in FIG. 1 as the servers 143, 150, 154, and 158) on which operations of the subject system are completed. Included is a processor 602, suitably comprised of a central processor unit. However, it will be appreciated that processor 602 may advantageously be composed of multiple processors working in concert with one another as will be appreciated by one of ordinary skill in the art. Also included is a non-volatile or read only memory 604 which is advantageously used for static or fixed data or instructions, such as BIOS functions, system functions, system configuration, and other routines or data used for operation of the server 600.

Also included in the server 600 is random access memory 606, suitably formed of dynamic random access memory, static random access memory, or any other suitable, addressable memory system. Random access memory provides a storage area for data instructions associated with applications and data handling accomplished by the processor 602.

A storage interface 608 suitably provides a mechanism for volatile, bulk or long term storage of data associated with the server 600. The storage interface 608 suitably uses bulk storage, such as any suitable addressable or serial storage, such as a disk, optical, tape drive and the like as shown as 616, as well as any suitable storage medium as will be appreciated by one of ordinary skill in the art.

A network interface subsystem 610 suitably routes input and output from an associated network allowing the server 600 to communicate to other devices. The network interface subsystem 610 suitably interfaces with one or more connections with external devices to the server 600. By way of example, illustrated is at least one network interface card 614 for data communication with fixed or wired networks, such as Ethernet, token ring, and the like, and a wireless interface 618, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 614 is interconnected for data interchange via a physical network 620, suitably comprised of a local area network, wide area network, or a combination thereof.

Data communication between the processor 602, read only memory 604, random access memory 606, storage interface 608, and the network subsystem 610 is suitably accomplished via a bus data transfer mechanism, such as illustrated by bus 612.

Suitable executable instructions on the server 600 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 622 as will be appreciated by one of ordinary skill in the art.

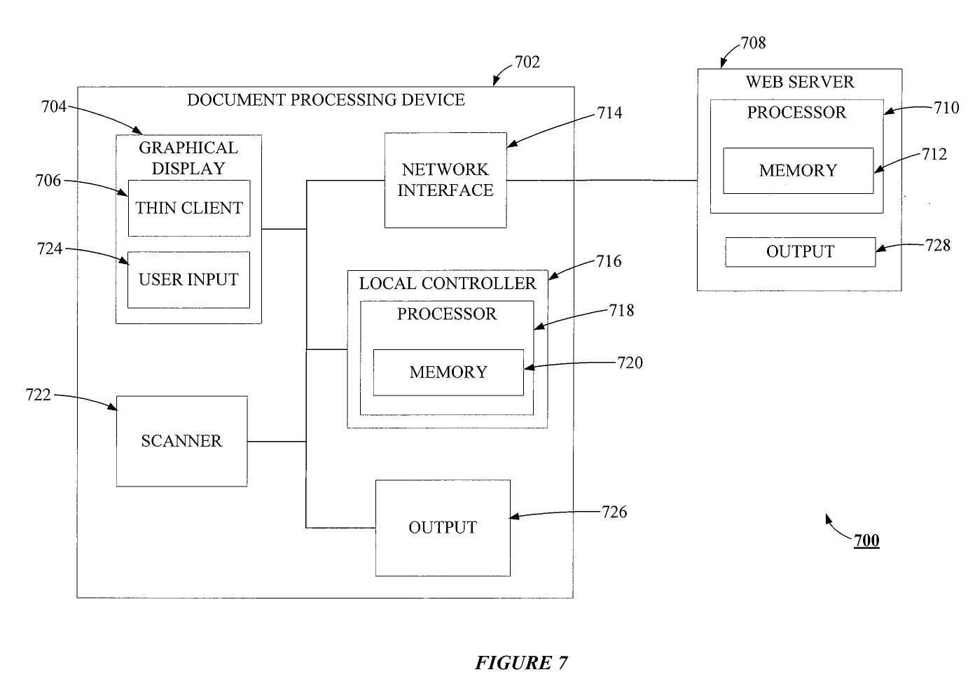

Referring now to FIG. 7, illustrated is a block diagram of system 700 for server-directed document input via a document processor interface in accordance with one embodiment of the subject application. As shown in FIG. 7, the system 700 includes a document processing device 702 having an associated graphical display 704, with a thin client application 706 operable on the graphical display 704. The system 700 also includes a web server 708, having a processor 710 and memory 712, in network data communication with the thin client application 706 via a network interface 714. The document processing device 702 also includes a local controller 716, which includes a processor 718 and memory 720. According to one embodiment of the subject application, the controller 716 is configured engage functional operation of the document processing device 702 via software instruction. The document processing device 702 also incorporates an integrated scanner 722 under operational control of the controller 716.

The system 700 further includes a user input 724 associated with the graphical display 704 and the thin client application 706 and operable to receive user instructions relative to commencement of a document scanning operation. The document processing device 702 further includes an output 726 operable to communicate data corresponding to received user instructions to the web server 708 via the network interface 714. According to one embodiment of the subject application, the web server 708 includes instructions operable to receive the data corresponding to the received user instructions and is operable to generate device control instructions corresponding to the received user instructions. The web server 708 further includes an output 728 operable to communicate the device control instructions to the document processing device 702 via the network interface 714. Preferably, the local controller 716 is configured to receive the device control instructions and to commence operation of the scanner 722 in accordance with such device control instructions. The scanner 722 of the document processing device 702 is operable to generate an electronic document corresponding to a tangible document positioned relative to the scanner 722 based upon the received device control instructions. In addition, the network interface 714 is preferably configured to communicate the electronic document to the server 708.

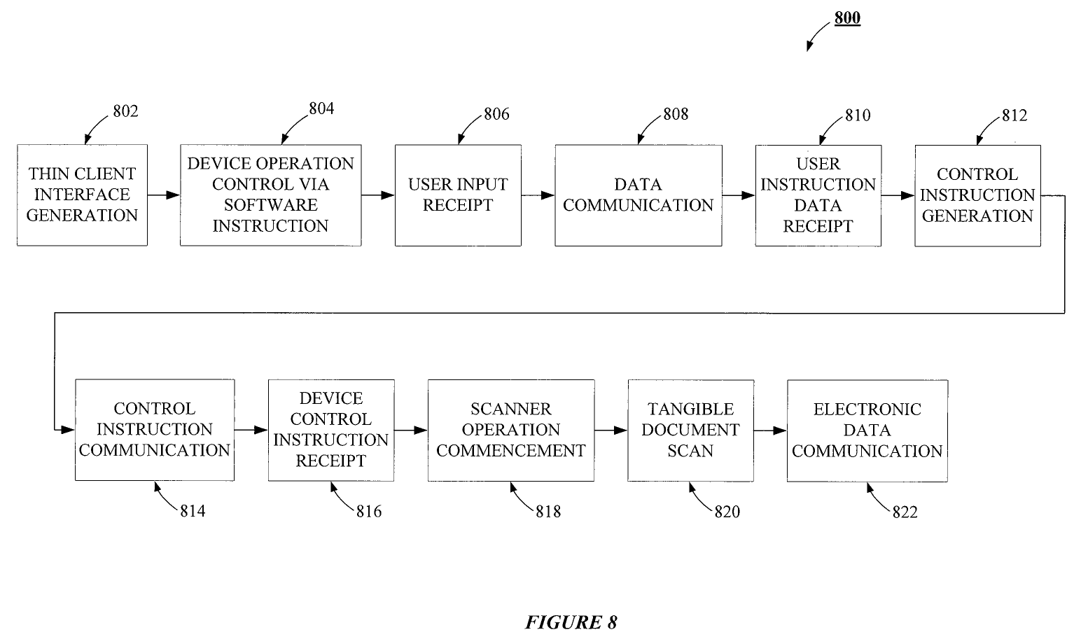

Turning now to FIG. 8, illustrated is a functional diagram of a system 800 for server-directed document input via a document processor interface in accordance with one embodiment of the subject application. As shown in FIG. 8, thin client interface generation 802 is first performed on a graphical display associated with a document processing device via a web server. Preferably, the document processing device includes an associated processor and memory, and is in data communication with an associated network. Via a local controller equipped with a processor and associated memory, document processing device control 804 occurs based upon software instructions corresponding thereto. User input receipt 806, via the graphical display, then occurs of user instructions relative to the commencement of a document processing device scanning operation. Data communication 808 is then performed of the received user instructions to the web server via a network interface.

Next, user instruction data receipt 810 occurs at the web server of data corresponding to the user instructions. Device control instruction generation 812 is then performed generating control instructions corresponding to the received user instructions. Control instruction communication 814 then occurs of the generated device control instructions to the document processing device via the network interface. Device control instruction receipt 816 then occurs via the receipt of the instructions by the local controller. Scanner operation commencement 818 is then performed corresponding to the commencement of operations of the scanner integrated with the document processing device based upon those received device control instructions. A tangible document scan 820 is then performed by the scanner of a tangible document positioned relative to the scanner so as to generate an electronic document corresponding thereto. Preferably, the scanner is operated at 820 in accordance with the received device control instructions. Thereafter, electronic data communication 822 of the electronic document to the web server via the network interface is performed.

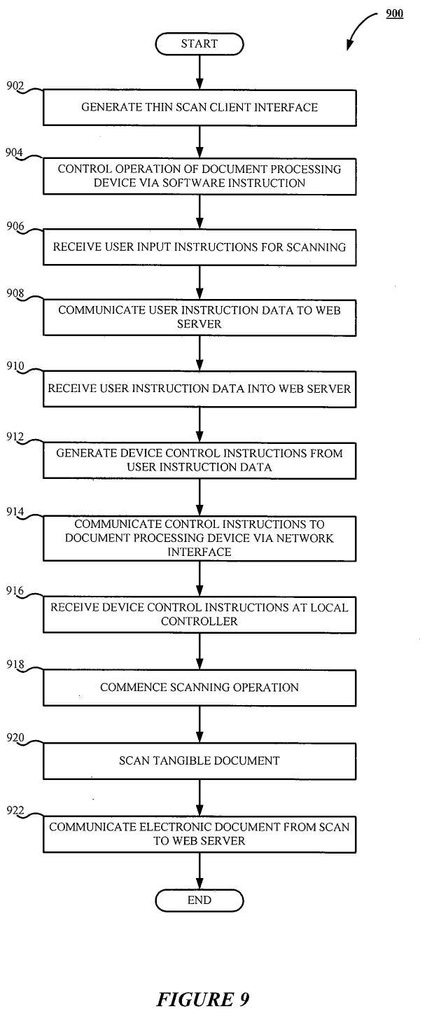

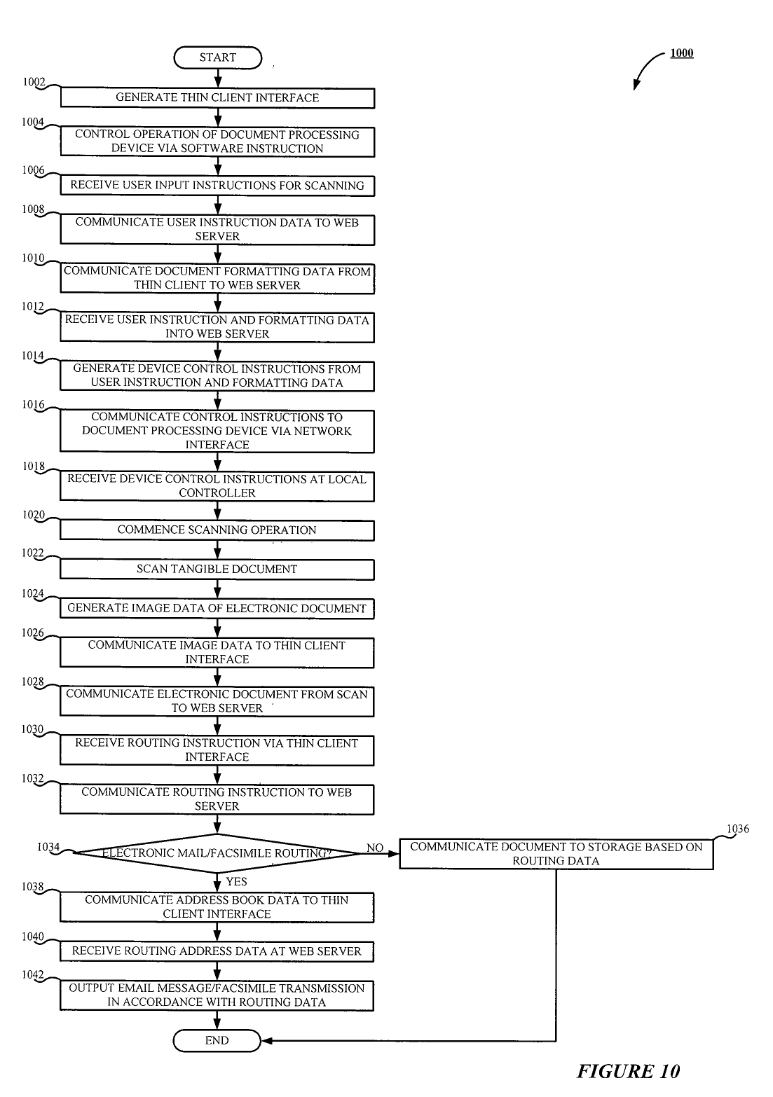

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9 and FIG. 10. Turning now to FIG. 9, there is shown a flowchart 900 illustrating a method for server-directed document input via a document processor interface in accordance with one embodiment of the subject application. Beginning at step 902, a thin client interface is generated operable on a graphical display associated with a document processing device via a web server. Preferably, the document processing device has a processor and memory in network data communication with the web server. At step 904, the document processing device is controlled via a local controller equipped with a processor and memory using software instructions.

Operations then proceed to step 906, whereupon user input is received via the graphical display. Preferably, the user input is representative of user instructions relative to commencement of a document scanning operation. At step 908, data corresponding to received user instructions is communicated to the web server via a network interface. The web server then receives the data corresponding to the received user instructions at step 910. At step 912, device control instructions are generated corresponding to the received user instructions. The device control instructions are then communicated to the document processing device via the network interface at step 914. The local controller associated with the document processing device then receives the device control instructions at step 916.

At step 918, operation of a scanner integrated with the document processing device is commenced in accordance with the received device control instructions. Scanning is then performed by the scanner at step 920 of an electronic document corresponding to a tangible document positioned relative to the scanner in accordance with received device control instructions. Thereafter, at step 922, the electronic document is communicated from the document processing device to the web server via the network interface.

Referring now to FIG. 10, there is shown a flowchart 1000 illustrating a method for server-directed document input via a document processor interface in accordance with one embodiment of the subject application. For example purposes only, reference is made hereinafter to the method of FIG. 10 implemented via the first document processing device 104. The skilled artisan will appreciate that either such device 104 or 122 is capable of being implemented in accordance with the subject application. The methodology of FIG. 10 begins at step 1002, whereupon a thin client interface, e.g. the embedded web browser 140, is generated on a graphical display 106, 116 associated with the document processing device 104 via a suitable web server, depicted in FIG. 1 as any of the servers 144, 150, 154, or 158. It will be understood by those skilled in the art that the reference to a web server with respect to FIG. 10 refers to any of the servers 144, 150, 154, or 158 illustrated in FIG. 1, as each are suitably capable of interaction with the document processing device 104 in accordance with the methodology of FIG. 10. The skilled artisan will further appreciate that the document processing device 104 includes a processor, memory, and network interface in data communication with the computer network 102. Suitable examples of such components of the structure of the document processing device 104 are detailed more fully above with respect to FIGS. 2 and 3.

Control of the document processing device 104 is then undertaken at step 1004 by the local controller 108, which includes a processor and memory (as depicted above in FIGS. 4 and 5). Preferably, the controller 108 facilitates operations of the document processing device 104 via software instructions, as will be appreciated by those skilled in the art. At step 1006, user input is received via the graphical display 106 or 116, which input represents user instructions relative to the commencement of a document scanning operation to be performed by the document processing device 104. The user instruction data is then communicated to the web server 144, 150, 154, or 158 via the network interface associated with the document processing device 104 at step 1008.

At step 1010, document formatting data is communicated from the thin client interface 140 to the web server 144, 150, 154, or 158 via the network interface over the computer network 102. It will be appreciated by those skilled in the art that such formatting includes, for example and without limitation, color selection, resolution, file format, file name, and the like. The web server 144, 150, 154, or 158 then receives the user instruction data and the formatting data at step 1012. The web server 144, 150, 154, or 158 then generates, at step 1014, device control instructions based upon the received user instruction data and the received formatting data. The generated device control instructions, generated from the user instruction and formatting data, are then communicated from the web server 144, 150, 154, or 158 to the document processing device 104 over the computer network 102 via the network interface at step 1016.

At step 1018, the controller 108 receives the device control instructions from the web server 144, 150, 154, or 158. The controller 108 or other suitable component associated with the document processing device 104 then facilitates the commencement of operations of a scanner (illustrated in FIGS. 2 and 3) integrated with the document processing device 104 based upon the received device control instruction at step 1020. At step 1022, a tangible document is scanned by the document processing device 104 so as to generate an electronic document corresponding thereto in accordance with the received device control instructions. Image data representative of the scanned electronic document is then generated by the controller 108 or other suitable component associated with the document processing device 104 at step 1024. At step 1026, the image data is communicated to the thin client interface 140 for display to the user via the user interface 106, display 116, or the like.

The electronic document is then communicated from the document processing device 104 to the web server 144, 150, 154, or 158 at step 1028. At step 1030, routing instruction data is received from the associated user via the thin client interface 140. It will be appreciated by those skilled in the art that such routing instructions includes, for example and without limitation, electronic mailing instructions, data storage instructions, facsimile instructions, or the like. The received routing instruction data is then communicated to the web server 144, 150, 154, or 158 at step 1032. The web server 144, 150, 154, or 158 then determines, at step 1034, whether the routing instructions correspond to an electronic mail operation. That is, whether the user has selected to transmit the scanned electronic document as an attachment to an electronic mail message or as a facsimile transmission.

Upon a determination at step 1034 that the routing instructions do not indicate mail or facsimile routing, operations proceed to step 1036. At step 1036, the web server 144, 150, 154, or 158 routes the electronic document to a designated storage location in accordance with the received routing instructions. It will be appreciated by those skilled in the art that such storage is capable of including, for example and without limitation, a server 144, 150, 154, or 158, a network storage facility, a local storage device 110, or the like. When it is determined at step 1034 that electronic mail or facsimile routing is indicated by the received routing instructions, flow proceeds to step 1038. At step 1038, address book data is communicated from the web server 144, 150, 154, or 158 to the thin client interface 140 associated with the document processing device 104 for user selection of an associated address/facsimile number. Routing address data is then received at the web server 144, 150, 154, or 158 at step 1040 from the thin client interface 140 corresponding to the address or facsimile number selected by the user from the address book data. Thereafter, at step 1042, an email message or facsimile message is output based upon the routing address data received from the user.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for server-directed document input via a document processor interface comprising:
a document processing device having a graphical display associated therewith;
a thin client application operable on the graphical display;
a web server, having a processor and memory, in network data communication with the thin client application via a network interface;
a local controller, inclusive of a processor and memory, associated with the document processing device, the controller operable to engage functional operation of the document processing device via software instruction;
a scanner integrated with the document processing device and under operational control of the controller;
a user input associated with the graphical display and the thin client application and operable to receive user instructions relative to commencement of a document scanning operation;
an output operable to communicate data corresponding to received user instructions to the web server via the network interface;
the web server including instructions operable to receive the data corresponding to received user instructions and operable to generate device control instructions corresponding thereto;
an output associated with the web server operable to communicate the device control instructions to the document processing device via the network interface;
the controller operable to receive the device control instructions and to commence operation of the scanner in accordance therewith;
the scanner operable to generate an electronic document corresponding to a tangible document positioned relative to the scanner in accordance with received device control instructions; and
the network interface operable to communicate the electronic document to the server.

2. The system of claim 1 further comprising:
an image generator associated with the web server, the image data operable to generate image data corresponding to the electronic document; and
an output operable to communicate the image data to the thin client application so as to generate an image corresponding to the tangible document thereon.

3. The system of claim 2 further comprising:
the thin client operable to receive routing instruction data via the user input;
an output associated with the document processing device operable to communicate the routing instruction data to the server via the network interface; and
the server operable to commence a routing of the electronic document in accordance with received routing instruction data.

4. The system of claim 3 wherein the routing data includes data corresponding to an e-mail address, and wherein the web server is operable to output an e-mail message inclusive of the electronic document in accordance therewith.

5. The system of claim 3 wherein the routing data includes data corresponding to a storage location and wherein the web server is operable to communicate the electronic document to the storage location in accordance therewith.

6. The system of claim 4 further comprising an address book data storage associated with the web server, and wherein the web server is operable to selectively communicate address book data from the address book storage, via the network interface, to the thin client in accordance with user input received therefrom.

7. The system of claim 1 further comprising an output associated with the document processing device operable to relay document formatting data from the thin client to the web server via the network interface, and wherein the device control instructions include document formatting instruction corresponding to the document formatting data.

8. A method of server-directed document input via a document processor interface comprising the steps of:
generating a thin client interface operable on graphical display associated with a document processing device via a web server, the document processing device having a processor and memory and in network data communication therewith;
controlling, via a local controller, inclusive of a processor and memory, associated with the document processing device, operation of the document processing device via software instruction;
receiving user input via the graphical display representative of user instructions relative to commencement of a document scanning operation;
communicating data corresponding to received user instructions to the web server via a network interface;
receiving, into the web server, the data corresponding to received user instructions;
generating device control instructions corresponding to received user instructions;
communicating the device control instructions to the document processing device via the network interface;
receiving, into the controller, the device control instructions;
commencing operation of a scanner integrated with the document processing device in accordance with received device control instructions;
scanning, via the scanner, an electronic document corresponding to a tangible document positioned relative to the scanner in accordance with received device control instructions; and
communicating the electronic document to the web server via the network interface.

9. The method of claim 8 further comprising:
generating image data corresponding to the electronic document; and
communicating the image data to the thin client interface so as to generate an image corresponding to the tangible document thereon.

10. The method of claim 9 further comprising:
receiving routing instruction data via the thin client interface;
communicating the routing instruction data to the web server via the network interface; and
routing the electronic document in accordance with received routing instruction data.

11. The method of claim 10 wherein the routing data includes data corresponding to an e-mail address, and outputting, via the web server, an e-mail message inclusive of the electronic document in accordance therewith.

12. The method of claim 10 wherein the routing data includes data corresponding to a storage location and communicating, via the web server, the electronic document to the storage location in accordance therewith.

13. The method of claim 11 further comprising the step of communicating address book data from an address book storage on the web server, via the network interface, to the thin client interface in accordance with user input received therefrom.

14. The method of claim 8 further comprising the step of communicating document formatting data from the thin client interface to the web server via the network interface, and wherein the step of generating includes generating device control instructions inclusive of document formatting instruction corresponding to the document formatting data.

15. A system of server-directed document input via a document processor interface comprising:
a document processing device having a graphical display associated therewith;
means adapted for generating a thin client interface operable on graphical display associated with a document processing device via a web server, having a processor and memory, in network data communication therewith;
means adapted for controlling, via a local controller, inclusive of a processor and memory, associated with the document processing device, operation of the document processing device via software instruction;
means adapted for receiving user input via the graphical display representative of user instructions relative to commencement of a document scanning operation;
means adapted for communicating data corresponding to received user instructions to the web server via a network interface;
means adapted for receiving into the web server the data corresponding to received user instructions;
means adapted for generating device control instructions corresponding to received user instructions;
means adapted for communicating the device control instructions to the document processing device via the network interface;
means adapted for receiving into the controller the device control instructions;
means adapted for commencing operation of a scanner integrated with the document processing device in accordance with received device control instructions;
means adapted for scanning, via the scanner, an electronic document corresponding to a tangible document positioned relative to the scanner in accordance with received device control instructions; and
means adapted for communicate the electronic document to the web server via the network interface.

16. The system of claim 15 further comprising:
means adapted for generating image data corresponding to the electronic document; and
means adapted for communicating the image data to the thin client so as to generate an image corresponding to the tangible document thereon.

17. The system of claim 16 further comprising:
means adapted for receiving routing instruction data via the thin client interface;
means adapted for communicating the routing instruction data to the server via the network interface; and
means adapted for routing the electronic document in accordance with received routing instruction data.

18. The system of claim 17 wherein the routing data includes data corresponding to an e-mail address, and means adapted for outputting via the web server, an e-mail message inclusive of the electronic document in accordance therewith.

19. The system of claim 17 wherein the routing data includes data corresponding to a storage location and means adapted for communicating, via the web server, the electronic document to the storage location in accordance therewith.

20. The system of claim 20 further comprising means adapted for communicating address book data from an address book storage on the web server, via the network interface, to the thin client in accordance with user input received therefrom.

21. The system of claim 15 further comprising means adapted for communicating document formatting data from the thin client interface to the server via the network interface, and means adapted for generating device control instructions inclusive of document formatting instruction corresponding to the document formatting data.
